(19) United States
(12) Patent Application Publication
(10) Pub. No.: US 2025/0335028 A1
(43) Pub. Date: Oct. 30, 2025

(54) METHODS AND SYSTEMS FOR DYNAMICALLY CONFIGURING SENSOR EXPOSURES

(71) Applicant: Meta Platforms Technologies, LLC, Menlo Park, CA (US)

(72) Inventors: Justin Michael Davis, Bellevue, WA (US); Fabrizio Guerrieri, Santa Clara, CA (US); Oskar Linde, San Carlos, CA (US)

(21) Appl. No.: 18/146,961

(22) Filed: Dec. 27, 2022

(51) Int. Cl. H04N 25/589; H04N 25/78

(52) U.S. Cl. CPC G06F 3/014

(57) ABSTRACT

The disclosed computer-implemented method may include determining that a sensor is to gather data for first and second sensor operations within a specified time period that is dependent on an operational frequency of the sensor. The method may also include determining that an exposure center for the first sensor operations is to be altered to allow both the first and the second sensor operations to occur within the specified time period. Still further, the method may include dynamically calculating the exposure center for the first sensor operation that will allow both the first and the second sensor operations to occur within the specified time period. The method may also include triggering the sensor to perform the first sensor operation using the dynamically calculated exposure center, where the first and second sensor operations are both performed during the specified time period. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example computing environment in which dynamic exposure centering and asymmetric slots may be implemented to provide a wide exposure range for sensors.

FIG. 2 is a flow diagram of an exemplary method for implementing dynamic exposure centering and asymmetric slots to provide a wide exposure range for sensors.

FIG. 3 illustrates an embodiment of a timing chart in which multiple sensor operations are performed within a specified time period.

FIGS. 4A & 4B illustrate embodiments of timing charts in which exposure centers are dynamically changed for different sensor operations.

FIG. 5 illustrates an embodiment in which asymmetrical time slots are implemented to provide a wide exposure range for a sensor.

FIG. 6 illustrates a chart outlining example timings when using dynamic centering and symmetric time slots at 120 Hz.

FIG. 7 illustrates a chart outlining example timings when using dynamic centering and asymmetric time slots at 120 Hz.

FIG. 8 illustrates a chart outlining example timings when using dynamic centering and symmetric time slots at 90 Hz.

FIG. 9 illustrates a chart outlining example timings when using dynamic centering and asymmetric time slots at 90 Hz.

FIG. 10 is an illustration of exemplary augmented-reality glasses that may be used in connection with embodiments of this disclosure.

FIG. 11 is an illustration of an exemplary virtual-reality headset that may be used in connection with embodiments of this disclosure.

FIG. 12 is an illustration of exemplary haptic devices that may be used in connection with embodiments of this disclosure.

FIG. 13 is an illustration of an exemplary virtual-reality environment according to embodiments of this disclosure.

FIG. 14 is an illustration of an exemplary augmented-reality environment according to embodiments of this disclosure.

FIGS. 15A and 15B are illustrations of an exemplary human-machine interface configured to be worn around a user's lower arm or wrist.

FIGS. 16A and 16B are illustrations of an exemplary schematic diagram with internal components of a wearable system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to a system that implements dynamic exposure centering and/or asymmetric time slots to provide a wider exposure range for sensors. This may allow sensors to operate at higher frequencies, while still performing all of the expected sensor operations. Some sensing systems are designed to operate at 60 Hz or lower. Controlling and operating a sensor at 60 Hz may provide sufficient time to capture and read out image data or other sensor data. If, however, these sensors were to try to increase their sampling rate from 60 Hz to 90 Hz or even 120 Hz, they would not have sufficient time to expose the sensor to the environment and to read out the resulting data before the next cycle. As such, increases from 60 Hz to 90 Hz, 120 Hz, or higher, are not trivial.

In the embodiments herein, dynamic exposure centering, asymmetric time slots, and other techniques may be implemented to allow sensors to operate at 90 Hz, 120 Hz, or at even higher frequencies. As will be understood, some sensors may be capable of performing multiple functions. For instance, a camera or image sensor may be configured to gather image data during one cycle and gather peripheral tracking data on another cycle. Gathering and reading out image data to memory may take a specific, known amount of time. Likewise, gathering peripheral tracking data may also take a specific, known amount of time. These times may differ from each other, however, and this difference in time may allow the dynamic exposure centering and asymmetric time slot embodiments described herein to operate.

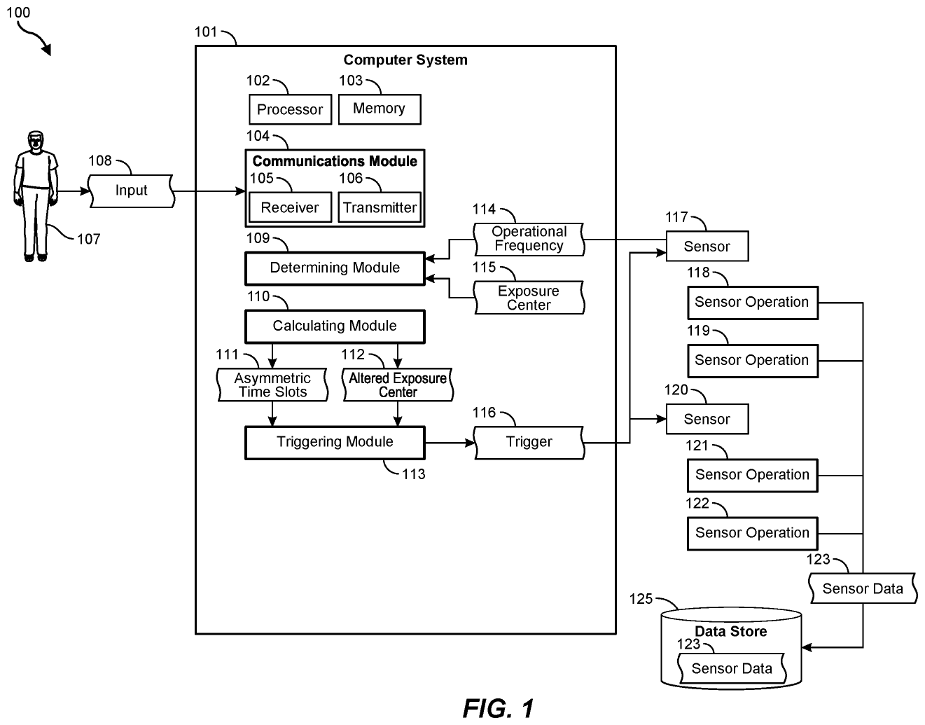

The embodiments described herein may implement various techniques to allow operation at high frequencies. These embodiments ensure that each sensing function has sufficient time for exposure and data readout before the next exposure for the next sensing operation starts. In one technique, instead of using symmetric time slots where exposure and data readouts occur within a fixed-length, symmetric time slot, the embodiments herein may implement asymmetric time slots that allow some sensor operations (e.g., tracking engines that use active illumination) to operate within a narrower time window, while allowing other sensor operations (e.g., simultaneous location and tracking (SLAM) operations) to operate in wider time windows. In another technique, instead of centering the exposure at a fixed point in time, the embodiments herein may allow for dynamic exposure centering in which the center of the sensor's exposure cycle is dynamically moved based on desired exposure values. In some cases, these embodiments may also change the upper and/or lower exposure limits for the sensor. Each of these techniques may be used in isolation or in combination to reach full sensor operation at 90 Hz, 120 Hz, or higher. Each of these embodiments will be described further below with regard to FIGS. 1-16B.

Features from any of the embodiments described herein may be used in combination with one another in accordance with the general principles described herein. These and other embodiments, features, and advantages will be more fully understood upon reading the following detailed description in conjunction with the accompanying drawings and claims.

FIG. 1 illustrates a computing environment 100 that includes a computer system 101. The computer system 101 may be substantially any type of computer system including a local computer system or a distributed (e.g., cloud) computer system. The computer system 101 may include at least one processor 102 and at least some system memory 103. The computer system 101 may also include program modules for performing a variety of different functions. The program modules may be hardware-based, software-based, or may include a combination of hardware and software. Each program module may use computing hardware and/or software to perform specified functions, including those described herein below.

For example, the communications module 104 may communicate with other computer systems. The communications module 104 may include wired or wireless communication means that receive and/or transmit data to or from other computer systems. These communication means may include hardware radios including, for example, a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, or other types of radios. The communications module 104 may interact with databases, mobile computing devices (such as mobile phones or tablets), embedded or other types of computing systems. In one case, for example, the receiver 105 may receive input 108 from a user 107. This input may alter the manner in which one or more of the modules of computer system 101 may operate.

The computer system 101 may also include a determining module 109. The determining module 109 may be configured to determine that a sensor (e.g., 117 or 120) is to gather data for different sensor operations within a time period that is dependent on the operational frequency of the sensor. As noted above, the sensors herein may be designed to operate at specific frequencies (e.g., 60 Hz, 90 Hz, 120 Hz, etc.). Each cycle may introduce an opportunity for the sensor to capture sensor data and read that data out to memory (either to temporary or permanent storage, for example, in data store 125). The length of each cycle or each period thus depends on the frequency at which the sensors are operating. The determining module 109 may thus determine in one case that a sensor is to gather data for different sensor operations within a time period that is 1/60^{th} of a second, 1/90^{th} of a second, 1/120^{th} of a second, or some other time period that depends on the frequency of the sensor.

In some cases, the determining module 109 may further be configured to determine that an exposure center is to be altered for at least one of the sensor operations (e.g., 118, 119, 121, or 122) that are to occur. As the term is used herein, an “exposure center” may refer to the center position in a sensor operation. Thus, if the sensor is capturing image data, the exposure center for image data capturing may be halfway between when the sensor starts capturing image data and when the sensor finishes capturing image data. Similarly, if the sensor is capturing peripheral tracking data (e.g., constellation data for a handheld controller), the exposure center for peripheral tracking data capturing may be halfway between when the sensor starts capturing peripheral tracking data and when the sensor finishes capturing the peripheral tracking data.

In some cases, the determining module 109 may determine that the exposure center for a specific sensor operation is to be changed to ensure that multiple sensor operations (e.g., first and the second sensor operations 118/119) occur within a specified time period. The calculating module 110 may then calculate a new, different exposure center 112 for the sensor operation that allows both the first and the second sensor operations to occur within the same specified time period. The triggering module 113 may then trigger the sensor (e.g., 117 or 120) to perform the sensor operation using the dynamically calculated exposure center 112. This may then allow both sensor operations to be carried out during the 1/90^{th} of a second, 1/120^{th} of a second, or other time period of the sensor.

The triggering module 113 may be configured to generate and send sensor trigger signals 116 to various sensors 117 or 120. The sensor trigger signals 116 may indicate that the sensors 117 or 120 are to begin sensing data. In some cases, the same sensor trigger signal 116 may be sent to multiple sensors (e.g., 117 and 120), or in other cases, different sensor trigger signals 116 may be sent to each sensor. The sensors 117 and 120 may be substantially any type of sensor, including visible light sensors (e.g., cameras), infrared light sensors, audio sensors, motion sensors, electrical impulse sensors, inertial motion units, accelerometers, biometric sensors, proximity sensors, ambient light sensors, magnetometers, microphones, touchscreens, heart rate sensors, or other types of sensors. Indeed, any sensor that allows sensing settings to be changed including dynamic centering and/or asymmetric time slots may be used.

In some cases, a single type of sensor may be used to sense different types of information. For instance, an electronic device such as an artificial reality headset may include multiple cameras. In such cases, for instance, sensors 117 and 120 may both be front-facing cameras on a controller or virtual reality headset that face away from a user. Other cameras may be rear facing and, as such, may sense information related to the user's face and/or body. Many other sensors may be used if desired. In this example, each of these cameras (or other sensors) may be used to perform multiple functions including hand tracking, upper body tracking, inside out tracking, eye tracking, controller tracking, depth sensing, face tracking, or other functions. This, as noted above, may be accomplished by dynamically changing the centering of each sensor operation and/or implementing asymmetric time slots.

Each time a sensor captures data, that data is either stored (at least temporarily) or discarded and subsequently overwritten. As shown in FIG. 1, sensor data 123 captured by any of sensors 117 or 120 may be stored in a data store 125. This data store 125 may be volatile memory (e.g., random access memory (RAM)) or non-volatile memory (e.g., hard disk, solid-state storage (SSD), etc.). The sensor data 123 may be stored for a brief amount of time or may be stored long-term. The amount of time needed to read out and store the sensor data 123 may be referred to herein as “readout time” or “sensor data readout time.” This is the time needed to access each of the sensing cells of the sensor (e.g., photodiodes in the case of cameras) and transfer that information to the data store 125. This amount of time is typically fixed for each given sensor and may not be changeable.

In general, sensor data readout begins substantially immediately after exposure ends, and a new exposure can start before the previous frame's readout is complete (e.g., when exposures are performed in an overlapped/pipelined manner). Still further, a sensor data readout cannot start before the previous frame's readout is complete. As such, a sensor exposure cannot end before the previous frame's readout has completed. At 60 Hz, with a period of 16.6 ms, 9.6 ms would be used reading out data and 7 ms could be used for sensor operations. At least in some cases, the frame-to-frame period (e.g., 16.7 ms at 60 Hz) minus the sensor data readout time would be equal to half the exposure range that can be supported in a given time slot. As such, at 60 Hz, the exposure range would be 7+7 ms or 14 ms exposure range (min: 0 ms, max: 14 ms). At 120 Hz, the readout time is ˜7 ms, with a maximum exposure (using symmetric slots) of (8.3−7)×2=2.6 ms (min: 0 ms, max: 2.6 ms).

In some cases, the embodiments herein may widen some time slots and make other time slots narrower. For example, instead of having symmetric slots every 8.3 ms (120 Hz), the embodiments herein may have alternating slots with sizes 9.5 and 7.2 ms (2 frames every 16.7 ms->120 Hz). This would gain exposure range in the wide slot at the expense of the narrow one. This trade-off may allow multiple different tracking engines or sensor functions that use relatively short exposures (e.g., constellation or depth tracking) to work alongside other sensor functions that use longer exposures.

At least some of the embodiments described herein may dynamically move the exposure center (and lower/upper exposure limits) to achieve desired exposure values. For example, in the example asymmetric triggering scheme described above, the system may support a 5.5 ms exposure range in the longer time slot. The system may thus support an exposure range of 0->5.5 ms, or may support 1->6.5 ms, or 2->7.5 or some other 5.5 ms increment. Depending on the range selected, the systems herein may select a different, altered exposure center. This may be performed at runtime by selecting the exposure center based on the highest and lowest exposure values. If, in some cases, a user was to request multiple exposures in the same slot with too wide of a range, the systems herein may change the values up or down to work properly. By implementing such a dynamic exposure centering mechanism, the embodiments herein may simulate having an exposure range of 0->9.4 ms in a simple two-slot asymmetric scheme.

In the embodiments described herein, various formulas may be implemented to calculate altered exposure centers and determine asymmetrical time slots. The following terms and definitions may be used herein: “num_slots” may refer to the number of slots in a composite period; “composite_period” may refer to the sum of all slot durations; “sN_period” may refer to the period of time slot N (where N is a numerical variable); “readout” may refer to the amount of time needed to transmit a single frame from a sensor to the (temporary or permanent) data store; “sN_exposure_max/min” may refer to the maximum & minimum exposure values supported concurrently in slot N; “sN_exposure_range” may refer to sN_exposure_max−sN_exposure_min; “sN_dynamic_exposure_max” may refer to the highest supported value of sN_exposure_max when using dynamic centering; “readout_buffer” may refer to the amount of time that is guaranteed between the end of a slot's readout and the start of the next readout; and “effective_readout_time” may refer to a combination of the readout time and the readout_buffer.

One or more of the following formulas may be implemented when performing dynamic exposure centering and determining asymmetric time slots:

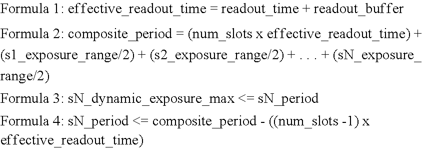

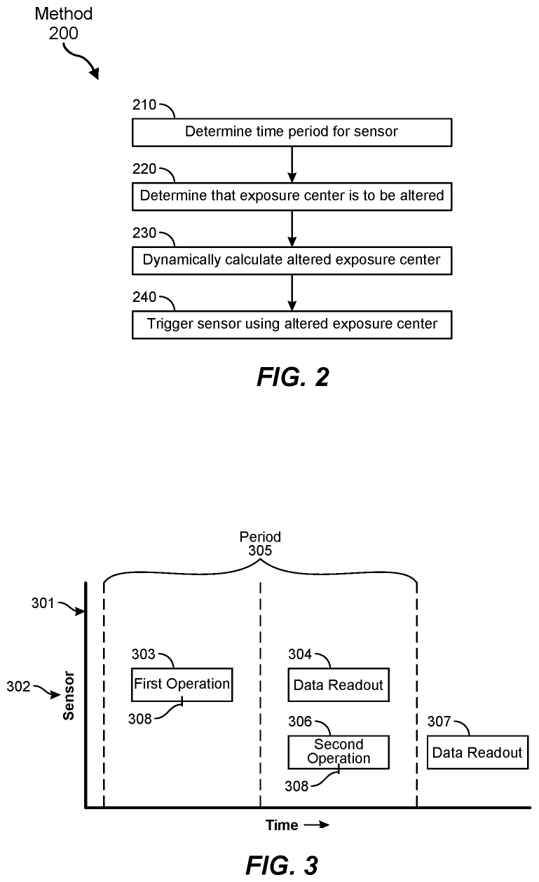

In at least some embodiments, readout_time may be fixed at 6.7 ms with a readout_buffer of 0.25 ms (with an effective_readout_time=6.95 ms). For simplicity, the embodiments described below are described at specific frequencies. That said, any embodiment described at 120 Hz or 90 Hz would also work at 100 Hz or 75 Hz or some other frequency. Furthermore, at least in some cases, the embodiments herein may adopt a combination of the above-described techniques. For instance, 120 Hz asymmetric time slots may be implemented in some scenarios or some of the time, but 90 Hz or 60 Hz mode may be implemented in different scenarios or at different times (e.g., in low-light scenarios to support higher exposures). These embodiments will be described further below with regard to method 200 of FIG. 2 and with regard to FIGS. 1 and 3-16B.

FIG. 2 is a flow diagram of an exemplary computer-implemented method 200 for implementing dynamic exposure centering and/or asymmetric slots to provide a wide exposure range for sensors. The steps shown in FIG. 2 may be performed by any suitable computer-executable code and/or computing system, including the system illustrated in FIG. 1. In one example, each of the steps shown in FIG. 2 may represent an algorithm whose structure includes and/or is represented by multiple sub-steps, examples of which will be provided in greater detail below.

At step 210 in Method 200, the computer system 101 of FIG. 1 may determine that a sensor is to gather data for first and second sensor operations within a specified time period that is dependent on an operational frequency of the sensor. Thus, for instance, the determining module 109 of computer system 101 may determine that sensor 117 is to gather sensor data for different sensor operations 118 and 119. In this case, sensor operations 118 and 119 are both to be performed during a specific time period (e.g., 8.3 ms if sensor 117 is operating at 120 Hz). As noted above, the time period may be different for different operating frequencies.

Then, at step 220 in Method 200, the computer system 101 may determine that an exposure center for the first sensor operations is to be altered to allow both the first and the second sensor operations to occur within the specified time period. Thus, the determining module 109 of computer system 101 may determine that the exposure center 115 for sensor operation 118 is to be changed to allow both the sensor operations 118 and 119 to occur within the 8.3 ms time period. Thus, for instance, if the sensor operation 118 includes image capture, the exposure center 115 may be moved to be longer than the normal default time that is halfway through the cycle. In this embodiment, the exposure center 115 for the sensor operation 119 may also be changed to be shorter than the normal default time that is halfway through the sensing cycle.

At step 230 of Method 200, the calculating module 110 of computer system 101 may dynamically calculate a new exposure center 115 for the first sensor operation 118 that will allow both the first and the second sensor operations 118/119 to occur within the specified time period (e.g., 8.3 ms). This calculation may occur dynamically for each sensor operation, and may be specific to each sensor. In the embodiments herein, various sensors may be monitored and analyzed to determine how long each sensing operation takes and how long each data readout resulting from that sensing operation takes.

Then, using this knowledge, the calculating module 110 may determine that, in order for one operation taking X amount of time, and in order for a second operation taking Y amount of time, for both operations to be performed within a specific time period based on the operational frequency of the sensor, the amount each exposure center is to be moved. In some cases, the calculating module 110 may dynamically calculate the center based on the high and low exposure for a particular time period. Because one exposure cannot end before the other readout is complete, the embodiments herein may shift the exposure center up to a specified value. The maximum amount of this shift is equivalent to the shortest minimum readout time. Once the calculating module 110 has calculated this amount for the sensor operations 118/119, the triggering module 113 may trigger, at step 240 of Method 200, the sensor 117 to perform the first sensor operation 118 using the dynamically calculated exposure center 112. Then, in this manner, the first and second sensor operations 118/119 are both performed during the specified time period.

FIG. 3 illustrates a timing chart in which multiple sensor operations are performed by the same sensor during a specified time period. For instance, the timing chart 301 may include two different operations that are to be performed, 303 and 306. These operations may include proximity sensing and biometric sensing, as example sensor operations. In this embodiment, each of these operations 303 and 306 is to be performed within time period 305. This time period 305 may be based on the operational frequency of the sensor 302. If the sensor is operating at 60 Hz, the time period 305 may be 16.6 ms, whereas if the sensor 302 is operating at 120 Hz, the time period 305 may be 8.3 ms. Other frequencies including higher or lower frequencies may also be used.

In the timing chart 301 of FIG. 3, each of the operations 303 and 306 may be equal in length but the second operation may have an exposure center 308 in the middle of the operation halfway through the time period. In other examples, as shown further below, the operations may have dynamically calculated exposure centers at different positions within the time period 305. Data readout 304/307 may last for a specific and known time after each operation 303/306 has been performed. Accordingly, in the example described above, the first operation 303 may perform proximity sensing and may read out proximity data at 304, and the second operation 306 may perform biometric sensing and may read out biometric data at 307, with both sensing operations having been performed within the time period 305. Thus, a single sensor may capture at least two different types of data using two different sensing operations during the time period 305. In some cases, the data readout (e.g., 304) may complete within the time period 305, while in other cases, the data readout (e.g., 307) may complete after the time period 305.

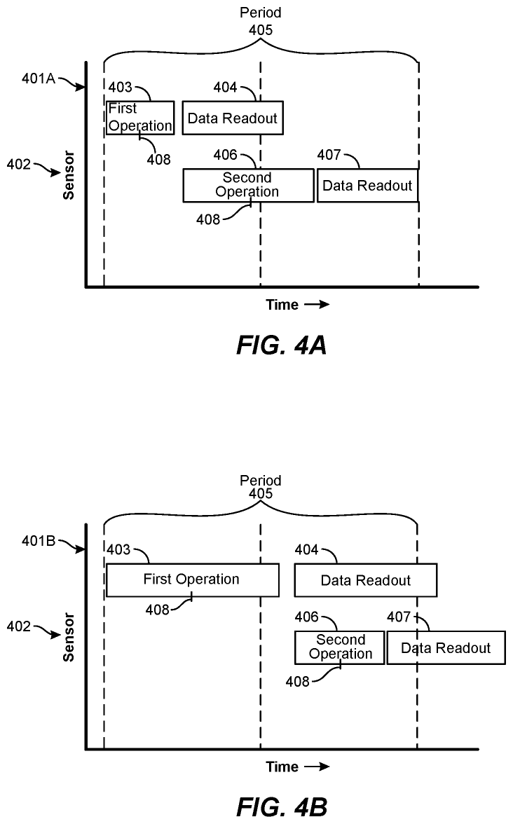

FIG. 4A illustrates an embodiment in which an exposure center for a sensor operation is changed from a default position to a position earlier in time within the specified time period. For example, in the timing chart 401A of FIG. 4A, a sensor 402 may perform a first operation 403. This first operation may be one that can be completed quickly and, as such, the calculating module 110 of FIG. 1 may dynamically calculate a new exposure center 408 that occurs earlier in time relative to a default position that would occur halfway through the first half of the period 405.

Instead, the exposure center 408 may occur at a point that is one quarter or one eighth of the way through the period 405. The data readout 404 for the first operation may then be initiated. Before the half point in period 405, the second operation 406 may then begin. Thus, the exposure center 408 of the second operation may also be move to a position earlier in time relative to the default, midway position. The second operation's data readout 407 may then take place. Thus, the calculating module 110 has flexibility to move the exposure centers ahead in time and, using the newly calculated exposure centers, the triggering module 113 may trigger the early initiation of the second operation 406.

Similarly, FIG. 4B illustrates an embodiment in which an exposure center for a sensor operation is changed from a default position, but in this case, the position is later in time within the specified time period. For instance, in the timing chart 401B of FIG. 4B, the sensor 402 may perform a first operation 403. This first operation may be different than the first operation of FIG. 4A, and may be one that cannot be completed quickly. Accordingly, the calculating module 110 may dynamically calculate a new exposure center 408 that occurs later in time relative to the default position that would occur halfway through the first half of the period 405.

In contrast, the exposure center 408 may occur at a point that is five eights, three quarters, or some other percentage of the way through the period 405. Upon completing the first operation 403, data readout 404 may begin. After the midpoint in period 405, the second operation 406 may then begin and, afterward, data readout 407. In this manner, the exposure center 408 of the second operation may also be move to a position later in time relative to the default, halfway position. Thus, it can be seen that the calculating module 110 also has flexibility to move the exposure centers back in time. Then, using the newly calculated exposure centers, the triggering module 113 may trigger the late initiation of the second operation 406 and potentially subsequent sensor operations.

In some embodiments, allowing multiple sensor operations (e.g., two, three, or more) to occur within the specified time period may include determining an exposure range and then ensuring that the exposure range is less than a dynamic exposure maximum. As noted above, the exposure range may refer to the sensor exposure's maximum value minus the senor exposure's minimum value. The computer system 101 or a user (e.g., 107) may set a dynamic exposure maximum value for a given sensor or a given set of sensor operations. Then, by ensuring that the exposure range is less than this maximum value, the system may ensure that the multiple different sensor operations will occur within the time period available (e.g., as dictated by the operating frequency of the sensor). For instance, as noted above, if a sensor supports 5.5 ms exposure range, the embodiments herein may implement an exposure range of 0->5.5 ms, or 1->6.5 ms, or 2->7.5 ms, etc. Different exposure centers may be calculated for each of these exposure ranges.

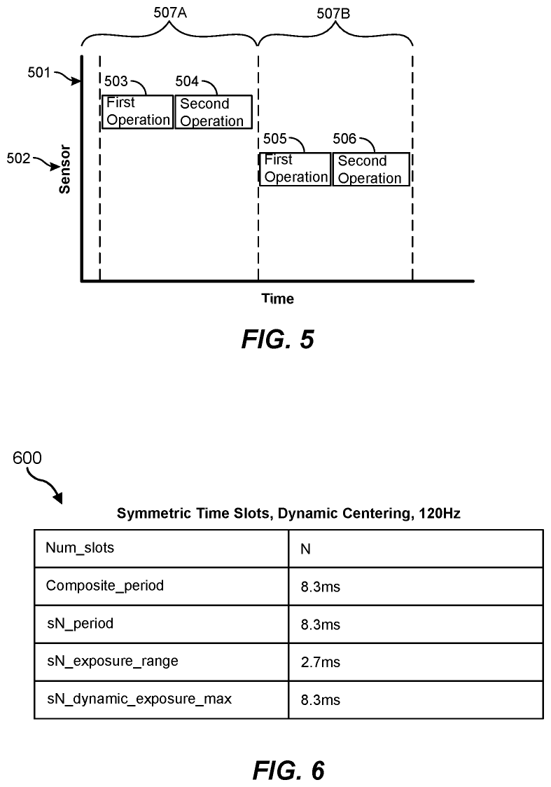

FIG. 5 illustrates an embodiment in which multiple time slots within a specified time period are triggered asymmetrically. In some systems, sensor operations are triggered sequentially, one after the other, with each time slot having the same value (e.g., 8.3 ms for 120 Hz). Using the embodiments described herein, at least some sensor operations may be triggered asymmetrically or, in other words, may use asymmetric time slots. The timing chart 501 of FIG. 5 shows multiple sensor operations performed over time by the sensor 502. In this timing chart 501, the first operation 503 is performed at an initial starting point, followed by a second operation 504 within the same time period 507A. This may be an asymmetric time period 507A that is longer, resulting in both operations 503/504 performed in, for example, 9.5 ms of the two-frame time period. The second time period in the two-frame period may be shorter, for example, 7.2 ms, equaling 16.7 ms for two frames (8.3 ms×2) at 120 Hz. This first and second operations 503/504 may be performed with a wider time slot (e.g., 9.5 ms) when needed for certain sensor operations that take longer to complete, and the first and second operations 505/506 of the second time period 507B may be performed in a narrower time slot (e.g., 7.2 ms).

Thus, in one example, the calculating module 110 of computer system 101 may calculate or otherwise identify asymmetric time slots 111 and may implement alternating time slots at 10 ms and 6.7 ms every two frames, for example, instead of one 8.3 ms frame at 120 Hz. Other alternating time slots with different values may also be used. The triggering module of computer system 101 may thus trigger the sensor operations 503/504 and 505/506 using the alternating, asymmetrical time slots within the specified time periods 507A/507B. Data readouts may occur or may at least be initiated within the alternating, asymmetric time slots. Accordingly, the calculating module 110 may create multiple time slots that are wider than a default time slot and may also create time slots that are narrower than a default time slot. These time slots may then alternate over two frames, four frames, eight frames, etc. in order to even out at a value equal to the period (derived from the frequency) at which the sensor is operating.

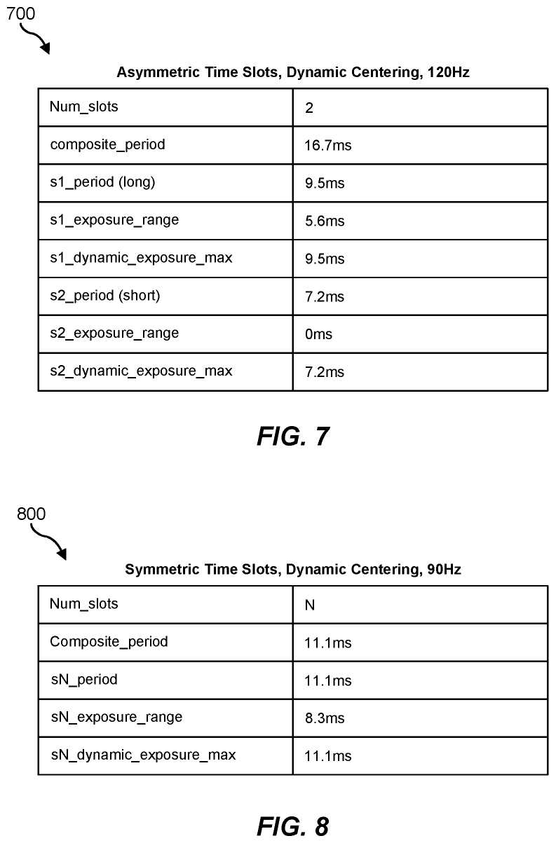

FIG. 6 illustrates a chart 600 in which a sensor implements dynamic centering and symmetric time slots at 120 Hz. In this chart 600, the number of time slots is a variable, N. The composite_period is 8.3 ms, the sN_period is 8.3 ms, the sN_exposure_range (difference between maximum and minimum exposure values in a specific time slot) is 2.7 ms, and the sN_dynamic_exposure_max is 8.3 ms. In chart 700 of FIG. 7, alternating wider and narrower time asymmetric slots may be used, again at 120 Hz. In this case, the number of slots is two, resulting in a composite_period of 16.7 ms at 120 Hz. The longer s1_period is 9.5 ms with an s1_exposure_range of 5.6 ms, while the shorter s2_period is 7.2 ms with an s2_exposure_range of 0 ms (i.e., all exposures in the shorter time slot are the same length). Within either of these scenarios, dynamic centering may be implemented to dynamically change when the exposure center occurs for a given sensor operation.

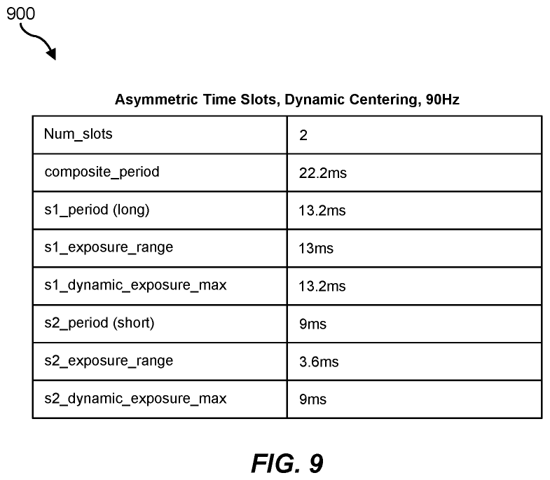

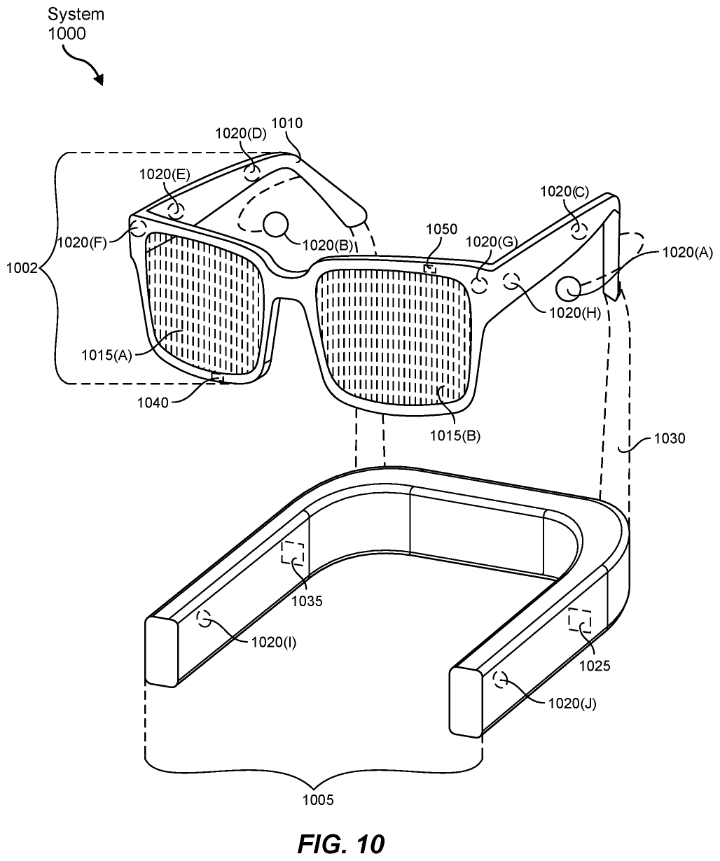

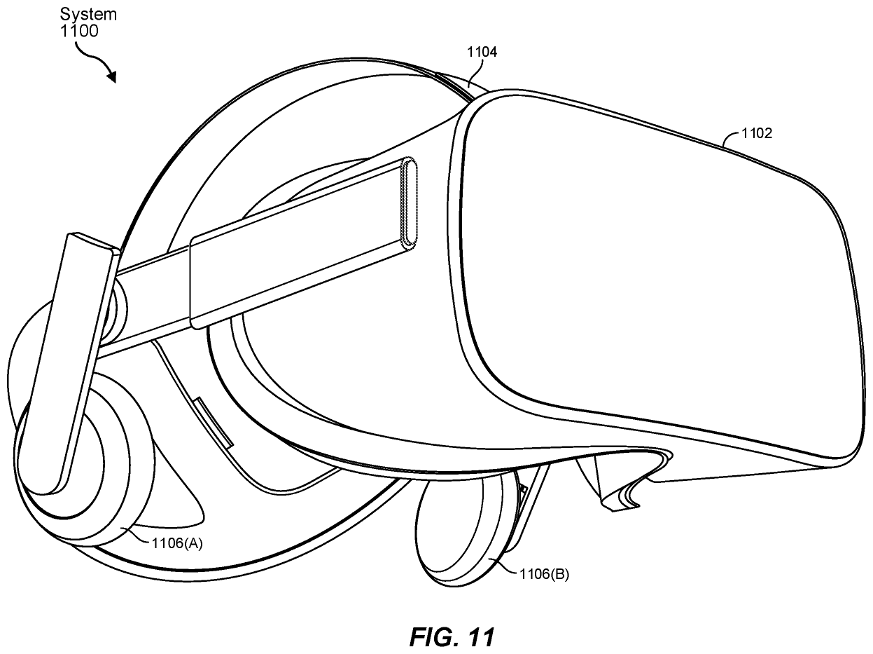

Similarly, as can be seen in chart 800 of FIG. 8, the systems herein may implement dynamic centering with symmetric time slots at 90 Hz. In such cases, the number of slots may be variable, and the composite_period may be equal to 11.1 ms ( 1/90^{th} of a second). Likewise, the sN_period and maximum exposure may also be 11.1 ms, while the sN_exposure_range at 90 Hz is 8.3 ms. Chart 900 of FIG. 9 illustrates an embodiment in which dynamic centering may be used with asymmetric time slots at 90 Hz. In such cases, the number of slots would be two, with a composite_period of 22.2 ms (11.1 ms x 2 frames), a longer period of 13.2 ms and a shorter period of 9 ms. It will be understood that other frequencies may be implemented, and that the formulas described herein may apply to many different sensors operating at many different frequencies. Moreover, it can be seen that dynamic exposure centering and the implementation of asymmetric time slots may be used, either alone or in combination, to allow sensors to operate at 90 Hz or 120 Hz or higher that typically would not be able to operate beyond 60 Hz. This may allow many new applications and implementations, particularly with regard to the virtual reality, augmented reality, and haptics devices described below with regard to FIGS. 10-16B.

In addition to the methods described above, a system may be provided that includes at least one physical processor and physical memory comprising computer-executable instructions that, when executed by the physical processor, cause the physical processor to: determine that a sensor is to gather data for first and second sensor operations within a specified time period that is dependent on an operational frequency of the sensor, determine that an exposure center for the first sensor operations is to be altered to allow both the first and the second sensor operations to occur within the specified time period, dynamically calculate the exposure center for the first sensor operation that will allow both the first and the second sensor operations to occur within the specified time period, and trigger the sensor to perform the first sensor operation using the dynamically calculated exposure center. In such cases, the first and second sensor operations may both be performed during the specified time period.

Still further, the embodiments described herein may include a non-transitory computer-readable medium that includes one or more computer-executable instructions that, when executed by at least one processor of a computing device, cause the computing device to: determine that a sensor is to gather data for first and second sensor operations within a specified time period that is dependent on an operational frequency of the sensor, determine that an exposure center for the first sensor operations is to be altered to allow both the first and the second sensor operations to occur within the specified time period, dynamically calculate the exposure center for the first sensor operation that will allow both the first and the second sensor operations to occur within the specified time period, and triggering the sensor to perform the first sensor operation using the dynamically calculated exposure center. In such cases, the first and second sensor operations may both be performed during the specified time period.

### Example Embodiments

Example 1: A computer-implemented method may include: determining that a sensor is to gather data for first and second sensor operations within a specified time period that is dependent on an operational frequency of the sensor, determining that an exposure center for the first sensor operations is to be altered to allow both the first and the second sensor operations to occur within the specified time period, dynamically calculating the exposure center for the first sensor operation that will allow both the first and the second sensor operations to occur within the specified time period, and triggering the sensor to perform the first sensor operation using the dynamically calculated exposure center, wherein the first and second sensor operations are both performed during the specified time period.

Example 2: The computer-implemented method of Example 1, wherein the first and second sensor operations are both performed by the same sensor during the specified time period.

Example 3: The computer-implemented method of Example 1 or Example 2, wherein the sensor captures at least two different types of data during the specified time period.

Example 4: The computer-implemented method of any of Examples 1-3, wherein the at least two different types of data are at least partially read out to memory during the specified time period.

Example 5: The computer-implemented method of any of Examples 1-4, wherein the exposure center is changed from a default position to a position earlier in time within the specified time period.

Example 6: The computer-implemented method of any of Examples 1-5, wherein the exposure center is changed from a default position to a position later in time within the specified time period.

Example 7: The computer-implemented method of any of Examples 1-6, wherein allowing both the first and the second sensor operations to occur within the specified time period includes determining an exposure range and ensuring that the exposure range is less than a dynamic exposure maximum.

Example 8: The computer-implemented method of any of Examples 1-7, further comprising: determining that at least two time slots within the specified time period are to be triggered asymmetrically, and triggering the at least two time slots within the specified time period asymmetrically.

Example 9: The computer-implemented method of any of Examples 1-8, wherein at least one of the time slots is wider than a default time slot.

Example 10: The computer-implemented method of any of Examples 1-9, wherein at least one of the time slots is narrower than a default time slot.

Example 11: The computer-implemented method of any of Examples 1-10, wherein the at least two time slots alternate between time slot widths.

Example 12: A system comprising: at least one physical processor and physical memory comprising computer-executable instructions that, when executed by the physical processor, cause the physical processor to: determine that a sensor is to gather data for first and second sensor operations within a specified time period that is dependent on an operational frequency of the sensor, determine that an exposure center for the first sensor operations is to be altered to allow both the first and the second sensor operations to occur within the specified time period, dynamically calculate the exposure center for the first sensor operation that will allow both the first and the second sensor operations to occur within the specified time period, and trigger the sensor to perform the first sensor operation using the dynamically calculated exposure center, wherein the first and second sensor operations are both performed during the specified time period.

Example 13: The system of Example 12, wherein the exposure center is changed from a default position to a position earlier in time within the specified time period.

Example 14: The system of Example 12 or Example 13, wherein the exposure center is changed from a default position to a position later in time within the specified time period.

Example 15: The system of any of Examples 12-14, wherein allowing both the first and the second sensor operations to occur within the specified time period includes determining an exposure range and ensuring that the exposure range is less than a dynamic exposure maximum.

Example 16: The system of any of Examples 12-15, further comprising: determining that at least two time slots within the specified time period are to be triggered asymmetrically, and triggering the at least two time slots within the specified time period asymmetrically.

Example 17: The system of any of Examples 12-16, wherein at least one of the time slots is wider than a default time slot.

Example 18: The system of any of Examples 12-17, wherein at least one of the time slots is narrower than a default time slot.

Example 19: The system of any of Examples 12-19, wherein the at least two time slots alternate between time slot widths.

Example 20: A non-transitory computer-readable medium comprising one or more computer-executable instructions that, when executed by at least one processor of a computing device, cause the computing device to: determine that a sensor is to gather data for first and second sensor operations within a specified time period that is dependent on an operational frequency of the sensor, determine that an exposure center for the first sensor operations is to be altered to allow both the first and the second sensor operations to occur within the specified time period, dynamically calculate the exposure center for the first sensor operation that will allow both the first and the second sensor operations to occur within the specified time period, and triggering the sensor to perform the first sensor operation using the dynamically calculated exposure center, wherein the first and second sensor operations are both performed during the specified time period.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented reality device 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015(A) and 1015(B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(I) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(I) and 1020(J) may be positioned on neckband 1005, thereby increasing the distance between the neckband acoustic transducers 1020(I) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light project (DLP) micro-displays, liquid crystal on silicon (LCOS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 1000 and 1100 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

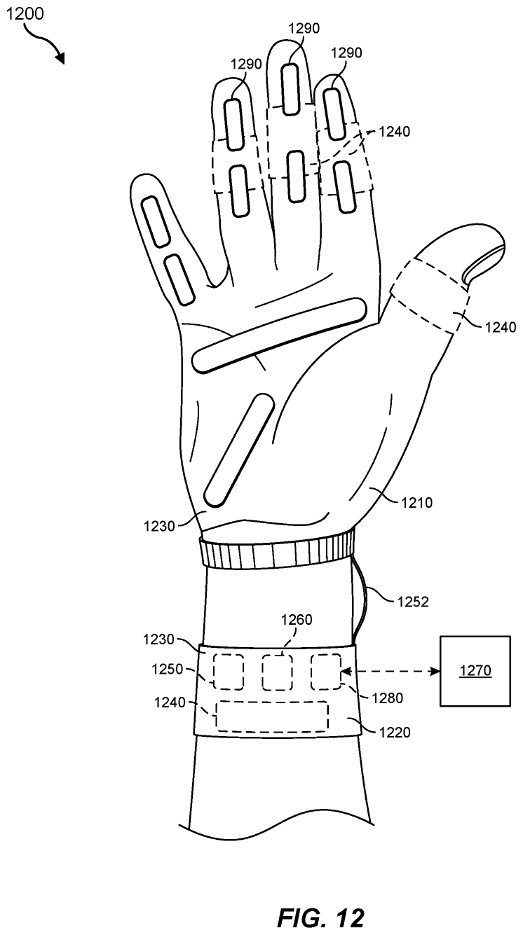

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 12 illustrates a vibrotactile system 1200 in the form of a wearable glove (haptic device 1210) and wristband (haptic device 1220). Haptic device 1210 and haptic device 1220 are shown as examples of wearable devices that include a flexible, wearable textile material 1230 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1240 may be positioned at least partially within one or more corresponding pockets formed in textile material 1230 of vibrotactile system 1200. Vibrotactile devices 1240 may be positioned in locations to provide a vibrating sensation (e.g., haptic feedback) to a user of vibrotactile system 1200. For example, vibrotactile devices 1240 may be positioned against the user's finger(s), thumb, or wrist, as shown in FIG. 12. Vibrotactile devices 1240 may, in some examples, be sufficiently flexible to conform to or bend with the user's corresponding body part(s).

A power source 1250 (e.g., a battery) for applying a voltage to the vibrotactile devices 1240 for activation thereof may be electrically coupled to vibrotactile devices 1240, such as via conductive wiring 1252. In some examples, each of vibrotactile devices 1240 may be independently electrically coupled to power source 1250 for individual activation. In some embodiments, a processor 1260 may be operatively coupled to power source 1250 and configured (e.g., programmed) to control activation of vibrotactile devices 1240.

Vibrotactile system 1200 may be implemented in a variety of ways. In some examples, vibrotactile system 1200 may be a standalone system with integral subsystems and components for operation independent of other devices and systems. As another example, vibrotactile system 1200 may be configured for interaction with another device or system 1270. For example, vibrotactile system 1200 may, in some examples, include a communications interface 1280 for receiving and/or sending signals to the other device or system 1270. The other device or system 1270 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 1280 may enable communications between vibrotactile system 1200 and the other device or system 1270 via a wireless (e.g., Wi-Fi, BLUETOOTH, cellular, radio, etc.) link or a wired link. If present, communications interface 1280 may be in communication with processor 1260, such as to provide a signal to processor 1260 to activate or deactivate one or more of the vibrotactile devices 1240.

Vibrotactile system 1200 may optionally include other subsystems and components, such as touch-sensitive pads 1290, pressure sensors, motion sensors, position sensors, lighting elements, and/or user interface elements (e.g., an on/off button, a vibration control element, etc.). During use, vibrotactile devices 1240 may be configured to be activated for a variety of different reasons, such as in response to the user's interaction with user interface elements, a signal from the motion or position sensors, a signal from the touch-sensitive pads 1290, a signal from the pressure sensors, a signal from the other device or system 1270, etc.

Although power source 1250, processor 1260, and communications interface 1280 are illustrated in FIG. 12 as being positioned in haptic device 1220, the present disclosure is not so limited. For example, one or more of power source 1250, processor 1260, or communications interface 1280 may be positioned within haptic device 1210 or within another wearable textile.

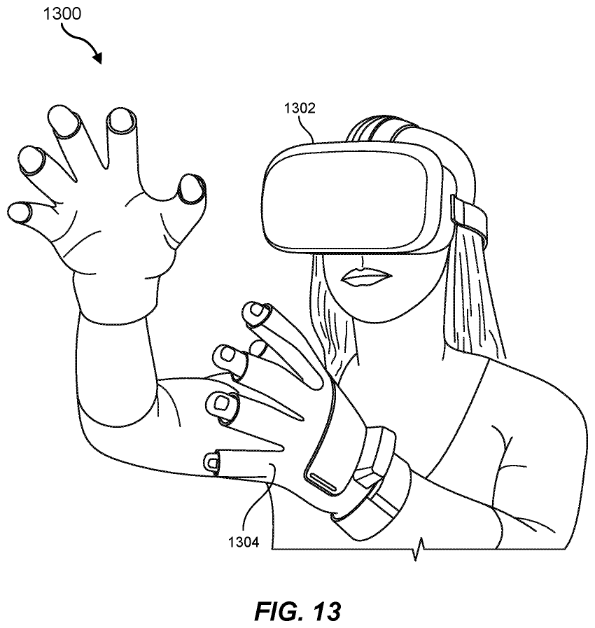

Haptic wearables, such as those shown in and described in connection with FIG. 12, may be implemented in a variety of types of artificial-reality systems and environments. FIG. 13 shows an example artificial-reality environment 1300 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1302 generally represents any type or form of virtual-reality system, such as virtual-reality system 1100 in FIG. 11. Haptic device 1304 generally represents any type or form of wearable device, worn by a user of an artificial-reality system, that provides haptic feedback to the user to give the user the perception that he or she is physically engaging with a virtual object. In some embodiments, haptic device 1304 may provide haptic feedback by applying vibration, motion, and/or force to the user. For example, haptic device 1304 may limit or augment a user's movement. To give a specific example, haptic device 1304 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1304 to send action requests to a console. Examples of action requests include, without limitation, requests to start an application and/or end the application and/or requests to perform a particular action within the application.

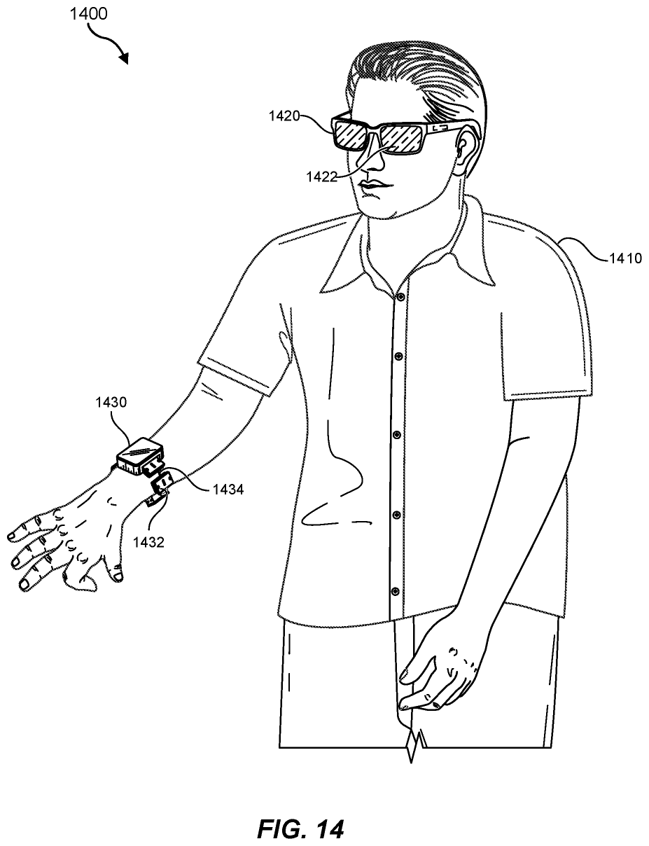

While haptic interfaces may be used with virtual-reality systems, as shown in FIG. 13, haptic interfaces may also be used with augmented-reality systems, as shown in FIG. 14. FIG. 14 is a perspective view of a user 1410 interacting with an augmented-reality system 1400. In this example, user 1410 may wear a pair of augmented-reality glasses 1420 that may have one or more displays 1422 and that are paired with a haptic device 1430. In this example, haptic device 1430 may be a wristband that includes a plurality of band elements 1432 and a tensioning mechanism 1434 that connects band elements 1432 to one another.

One or more of band elements 1432 may include any type or form of actuator suitable for providing haptic feedback. For example, one or more of band elements 1432 may be configured to provide one or more of various types of cutaneous feedback, including vibration, force, traction, texture, and/or temperature. To provide such feedback, band elements 1432 may include one or more of various types of actuators. In one example, each of band elements 1432 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1210, 1220, 1304, and 1430 may include any suitable number and/or type of haptic transducer, sensor, and/or feedback mechanism. For example, haptic devices 1210, 1220, 1304, and 1430 may include one or more mechanical transducers, piezoelectric transducers, and/or fluidic transducers. Haptic devices 1210, 1220, 1304, and 1430 may also include various combinations of different types and forms of transducers that work together or independently to enhance a user's artificial-reality experience. In one example, each of band elements 1432 of haptic device 1430 may include a vibrotactor (e.g., a vibrotactile actuator) configured to vibrate in unison or independently to provide one or more of various types of haptic sensations to a user.

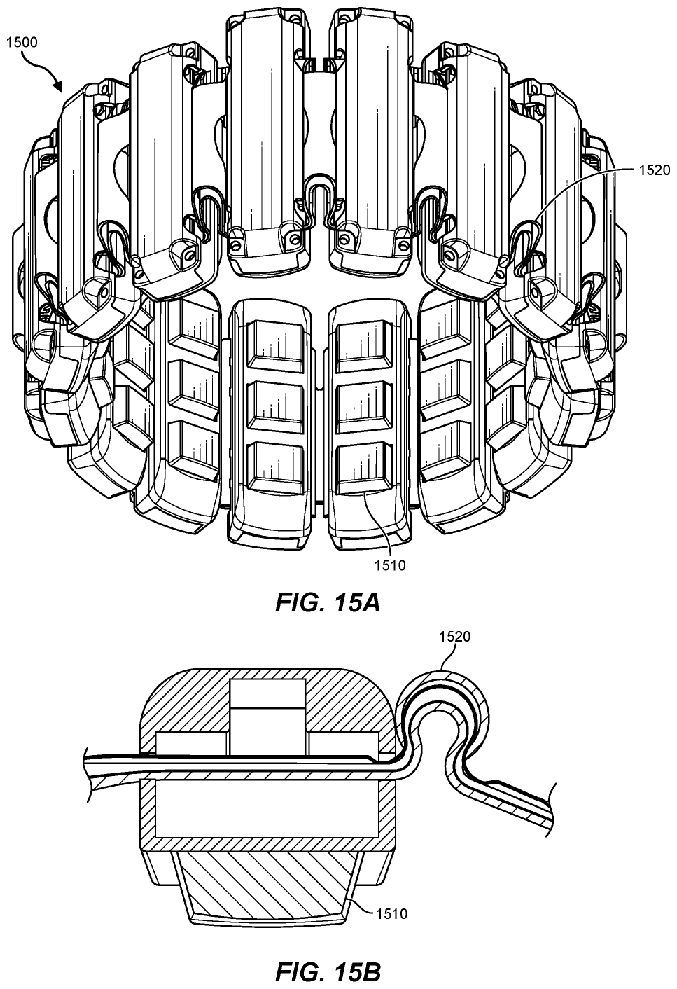

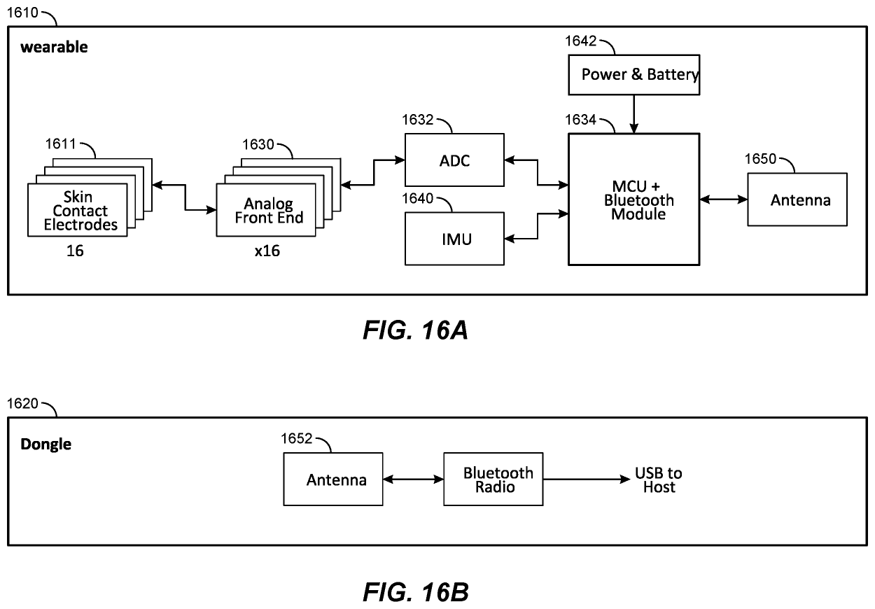

FIG. 15A illustrates an exemplary human-machine interface (also referred to herein as an EMG control interface) configured to be worn around a user's lower arm or wrist as a wearable system 1500. In this example, wearable system 1500 may include sixteen neuromuscular sensors 1510 (e.g., EMG sensors) arranged circumferentially around an elastic band 1520 with an interior surface configured to contact a user's skin. However, any suitable number of neuromuscular sensors may be used. The number and arrangement of neuromuscular sensors may depend on the particular application for which the wearable device is used. For example, a wearable armband or wristband can be used to generate control information for controlling an augmented reality system, a robot, controlling a vehicle, scrolling through text, controlling a virtual avatar, or any other suitable control task. As shown, the sensors may be coupled together using flexible electronics incorporated into the wireless device. FIG. 15B illustrates a cross-sectional view through one of the sensors of the wearable device shown in FIG. 15A. In some embodiments, the output of one or more of the sensing components can be optionally processed using hardware signal processing circuitry (e.g., to perform amplification, filtering, and/or rectification). In other embodiments, at least some signal processing of the output of the sensing components can be performed in software. Thus, signal processing of signals sampled by the sensors can be performed in hardware, software, or by any suitable combination of hardware and software, as aspects of the technology described herein are not limited in this respect. A non-limiting example of a signal processing chain used to process recorded data from sensors 1510 is discussed in more detail below with reference to FIGS. 16A and 16B.

FIGS. 16A and 16B illustrate an exemplary schematic diagram with internal components of a wearable system with EMG sensors. As shown, the wearable system may include a wearable portion 1610 (FIG. 16A) and a dongle portion 1620 (FIG. 16B) in communication with the wearable portion 1610 (e.g., via BLUETOOTH or another suitable wireless communication technology). As shown in FIG. 16A, the wearable portion 1610 may include skin contact electrodes 1611, examples of which are described in connection with FIGS. 15A and 15B. The output of the skin contact electrodes 1611 may be provided to analog front end 1630, which may be configured to perform analog processing (e.g., amplification, noise reduction, filtering, etc.) on the recorded signals. The processed analog signals may then be provided to analog-to-digital converter 1632, which may convert the analog signals to digital signals that can be processed by one or more computer processors. An example of a computer processor that may be used in accordance with some embodiments is microcontroller (MCU) 1634, illustrated in FIG. 16A. As shown, MCU 1634 may also include inputs from other sensors (e.g., IMU sensor 1640), and power and battery module 1642. The output of the processing performed by MCU 1634 may be provided to antenna 1650 for transmission to dongle portion 1620 shown in FIG. 16B.

Dongle portion 1620 may include antenna 1652, which may be configured to communicate with antenna 1650 included as part of wearable portion 1610. Communication between antennas 1650 and 1652 may occur using any suitable wireless technology and protocol, non-limiting examples of which include radiofrequency signaling and BLUETOOTH. As shown, the signals received by antenna 1652 of dongle portion 1620 may be provided to a host computer for further processing, display, and/or for effecting control of a particular physical or virtual object or objects.

Although the examples provided with reference to FIGS. 15A-15B and FIGS. 16A-16B are discussed in the context of interfaces with EMG sensors, the techniques described herein for reducing electromagnetic interference can also be implemented in wearable interfaces with other types of sensors including, but not limited to, mechanomyography (MMG) sensors, sonomyography (SMG) sensors, and electrical impedance tomography (EIT) sensors. The techniques described herein for reducing electromagnetic interference can also be implemented in wearable interfaces that communicate with computer hosts through wires and cables (e.g., USB cables, optical fiber cables, etc.)

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
determining that a sensor is to gather data for first and second sensor operations within a specified time period that is dependent on an operational frequency of the sensor;
determining that an exposure center for the first sensor operations is to be altered to allow both the first and the second sensor operations to occur within the specified time period;
dynamically calculating the exposure center for the first sensor operation that will allow both the first and the second sensor operations to occur within the specified time period; and
triggering the sensor to perform the first sensor operation using the dynamically calculated exposure center, wherein the first and second sensor operations are both performed during the specified time period.

2. The computer-implemented method of claim 1, wherein the first and second sensor operations are both performed by the same sensor during the specified time period.

3. The computer-implemented method of claim 2, wherein the sensor captures at least two different types of data during the specified time period.

4. The computer-implemented method of claim 3, wherein the at least two different types of data are at least partially read out to memory during the specified time period.

5. The computer-implemented method of claim 1, wherein the exposure center is changed from a default position to a position earlier in time within the specified time period.

6. The computer-implemented method of claim 1, wherein the exposure center is changed from a default position to a position later in time within the specified time period.

7. The computer-implemented method of claim 1, wherein allowing both the first and the second sensor operations to occur within the specified time period includes determining an exposure range and ensuring that the exposure range is less than a dynamic exposure maximum.

8. The computer-implemented method of claim 1, further comprising:
determining that at least two time slots within the specified time period are to be triggered asymmetrically; and
triggering the at least two time slots within the specified time period asymmetrically.

9. The computer-implemented method of claim 8, wherein at least one of the time slots is wider than a default time slot.

10. The computer-implemented method of claim 8, wherein at least one of the time slots is narrower than a default time slot.

11. The computer-implemented method of claim 8, wherein the at least two time slots alternate between time slot widths.

12. A system comprising:
at least one physical processor;
physical memory comprising computer-executable instructions that, when executed by the physical processor, cause the physical processor to:
determine that a sensor is to gather data for first and second sensor operations within a specified time period that is dependent on an operational frequency of the sensor;
determine that an exposure center for the first sensor operations is to be altered to allow both the first and the second sensor operations to occur within the specified time period;
dynamically calculate the exposure center for the first sensor operation that will allow both the first and the second sensor operations to occur within the specified time period; and
trigger the sensor to perform the first sensor operation using the dynamically calculated exposure center, wherein the first and second sensor operations are both performed during the specified time period.

13. The system of claim 12, wherein the exposure center is changed from a default position to a position earlier in time within the specified time period.

14. The system of claim 12, wherein the exposure center is changed from a default position to a position later in time within the specified time period.

15. The system of claim 12, wherein allowing both the first and the second sensor operations to occur within the specified time period includes determining an exposure range and ensuring that the exposure range is less than a dynamic exposure maximum.

16. The system of claim 12, further comprising:
determining that at least two time slots within the specified time period are to be triggered asymmetrically; and
triggering the at least two time slots within the specified time period asymmetrically.

17. The system of claim 16, wherein at least one of the time slots is wider than a default time slot.

18. The system of claim 16, wherein at least one of the time slots is narrower than a default time slot.

19. The system of claim 16, wherein the at least two time slots alternate between time slot widths.

20. A non-transitory computer-readable medium comprising one or more computer-executable instructions that, when executed by at least one processor of a computing device, cause the computing device to:
determine that a sensor is to gather data for first and second sensor operations within a specified time period that is dependent on an operational frequency of the sensor;
determine that an exposure center for the first sensor operations is to be altered to allow both the first and the second sensor operations to occur within the specified time period;
dynamically calculate the exposure center for the first sensor operation that will allow both the first and the second sensor operations to occur within the specified time period; and
triggering the sensor to perform the first sensor operation using the dynamically calculated exposure center, wherein the first and second sensor operations are both performed during the specified time period.
